(19) United States
(12) Patent Application Publication
(10) Pub. No.: US 2002/0123400 A1
(43) Pub. Date: Sep. 5, 2002

(54) Primary clutch

(76) Inventors: Bruce H. Younggren, Bemidji, MN (US); Brian G. Eck, Bemidji, MN (US); Shane Okeson, Mahnomen, MN (US)

Correspondence Address: Michael L. Mau, Mau & Krull, P.A., Suite E, 1250 Moore Lake Drive East, Fridley, MN, 55432, US

(21) Appl. No.: 10/135,914

(22) Filed: Apr. 30, 2002

Related U.S. Application Data
(62) Division of application No. 09/724,285, filed on Nov. 28, 2000.
(60) Provisional application No. 60/167,764, filed on Nov. 29, 1999.

(51) Int. Cl. F16H 59/00; F16H 61/00; F16H 63/00

(52) U.S. Cl. 474/14; 474/19

(57) ABSTRACT

A continuously variable drive element (100) has its torque transmission separate from its belt-squeezing function. The torque transmission is provided by only a first and second torque transmission tower and the belt-squeezing function is provided only by first and second belt-squeezing features. The preload of a compression spring is remotely adjustable without the need of disassembling the drive element.

### BACKGROUND OF THE INVENTION

1. Field of the Invention

This invention relates generally to a primary clutch and more particularly to a primary clutch having a pre-load adjuster and a primary clutch which uses only two transmission towers and two belt squeezing features.

2. Description of the Prior Art

Primary clutches work off of centrifugal force and are typically connected to an engine crank shaft. As the engine rotates, flyweights, which are connected to a moveable sheave, want to rotate radially from the axis of a post. The flyweight does this because the center of gravity of the weight is above (away from the engine) its pivot point. As the engine speed increases, the centrifugal force of the flyweights increase, thereby pushing against a spider. The spider is fixed to the post and cannot move. The stationary sheave is also fixed to the post and cannot move. A cover is fastened to the moveable sheave and both have bushings in them to allow them to slide axially on the post. A compression spring pushes against the fixed spider on one end and the sliding cover on the other. The spring is the reaction member that returns the clutch to neutral and opposes the flyweight force. As the engine RPM increases, the centrifugal force of the flyweights increases and the force on the moveable sheave sliding axially on the shaft towards the stationary sheave increases. Once there is enough force, the flyweights overcome the compression spring and apply a side force through the moveable sheave on a V-belt. This force pinches the belt between the moveable sheave and the stationary sheave. Once enough belt force is created, the vehicle will begin to move (clutch engagement). The side force of the belt is equal to the flyweight force (parallel to the post axis) minus the spring force.

It is often desirable to change the pre-load provided by the compression spring, or to change the flyweights, in order to adjust the side force on the belt. Once a user gets a compression spring/flyweight system that performs well, the user will usually change weights to raise or lower the engine RPM at wide open throttle. If the spring isn't changed, the engagement RPM will also change. Another method that a user could do is to put a shim between the spider and compression spring, thereby changing the preload force. Using the formula noted above, changing the weights will change the amount of side force on the belt. It is typically a time consuming and difficult process to change the flyweights. Similarly, to change the amount of preload on a spring usually requires disassembly to place the shim in position. The present invention addresses the problems associated with the prior art devices and provides for a simple and effective method of remotely changing the preload of the spring without disassembling the primary clutch.

Also, current primary clutches typically use three or four sliding buttons and typically have the torque transmission and belt squeezing functions together.

The present invention addresses the problems in the prior art and provides for a primary clutch which utilizes only two torque transmission towers and only two belt squeezing features to provide for a better primary clutch. Still further, the present invention provides for the separation of the torque transmission from the belt squeezing functions.

### SUMMARY OF THE INVENTION

The present invention is a continuously variable transmission drive element for mounting on an engine crank shaft and adapted for use in a belt-type continuously variable transmission operatively connected by an endless belt to a driven element, the drive element includes a post and a first, stationary sheave having a conically faced belt-contacting portion operatively connected to the post. A second moveable sheave has a conical faced belt-contacting portion and a housing operatively connected to the conical-faced portion. The housing also has first and second torque transmission towers, each tower defining a longitudinal path. The housing also includes only first and second belt-squeezing features. A connector is fixedly secured to the post, the connector has only a first and second torque transmission members and only a first and second belt-squeezing members. The torque transmission members are slidable in a longitudinal path of the towers. A compression spring is operatively connected to the moveable sheave to provide a biasing force tending to urge the moveable sheave away from the stationary sheave, where torque transmission is provided only by the first and second torque transmission towers and the first and second torque transmission members. The belt squeezing is provided only by the two belt-squeezing members and belt-squeezing features.

In another embodiment, the invention is a continuously variable transmission drive element for mounting on an engine crankshaft and adapted for use in a belt-type continuously variable transmission operatively connected by an endless belt to a driven element. The drive element includes a post and a first, stationary sheave operatively connected to the post. A second, moveable sheave is coaxially mounted on the post. A connector is fixedly mounted to the post, wherein the connector and the second sheave operate to move the second sheave longitudinally along the post to provide for belt squeezing and also to transmit torque. A compression spring is operatively connected to the moveable sheave to provide a preload to bias the moveable sheave away from the stationary sheave. An adjuster is provided to remotely change the preload of the compression spring.

In another embodiment, the invention is a continuously variable transmission drive element for mounting on an engine crankshaft and adapted for use in a belt-type continuously variable transmission operatively connected by an endless belt to a driven element. The drive element includes a post and a first, stationary sheave operatively connected to the post. A second, moveable sheave is coaxially mounted on the post. A connector is fixedly mounted to the post, wherein the connector and the second sheave operate to move the second sheave longitudinally along the post to provide for belt squeezing and also to transmit torque. A compression spring is operatively connected to the moveable sheave to provide a preload to bias the moveable sheave away from the stationary sheave. A means for adjusting the preload remotely is provided.

In another embodiment, the invention is a method of changing a preload on a compression spring in a continuously variable transmission drive element. The drive element has a preload compression spring operatively connected to the moveable sheave to provide a preload bias to urge the moveable sheave away from the stationary sheave. The method includes assembling a drive element with a first preload on a spring. Then, the method includes moving a spring preload adjusting member to cause longitudinal movement of a spring contacting member, thereby changing the first preload to a second preload, wherein the moving of the spring adjusting member is done remotely, without disassembling the drive element.

### BRIEF DESCRIPTION OF THE DRAWINGS

FIG. 1 is a perspective view of the primary clutch of the present invention;

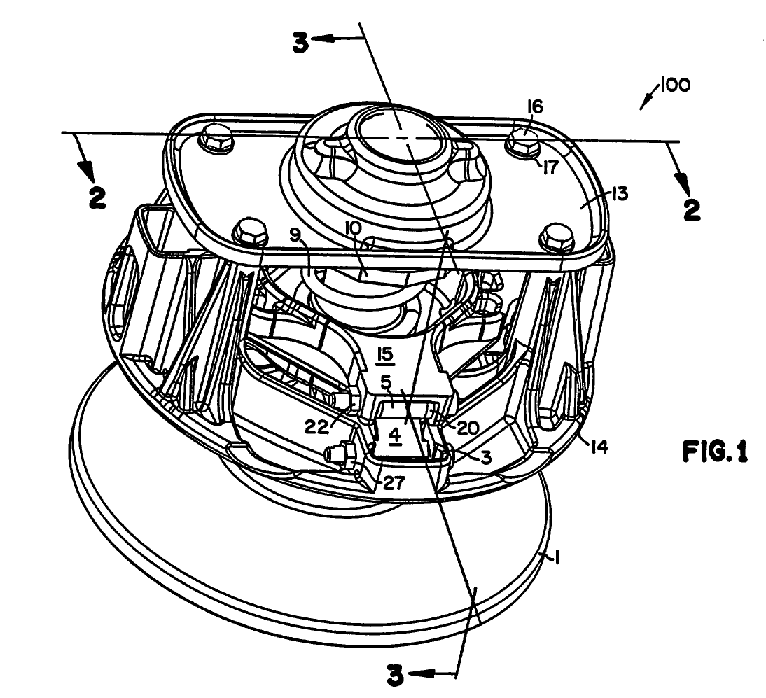

FIG. 2 is a cross-sectional view of the primary clutch shown in FIG. 1 taken generally along the lines 2-2;

FIG. 3 is a cross-sectional view of the clutch shown in FIG. 1 taken generally along the lines 3-3;

FIG. 4 is a perspective view of the primary clutch shown in FIG. 1, viewed from below;

FIG. 5 is a side elevational view of the clutch shown in FIG. 1;

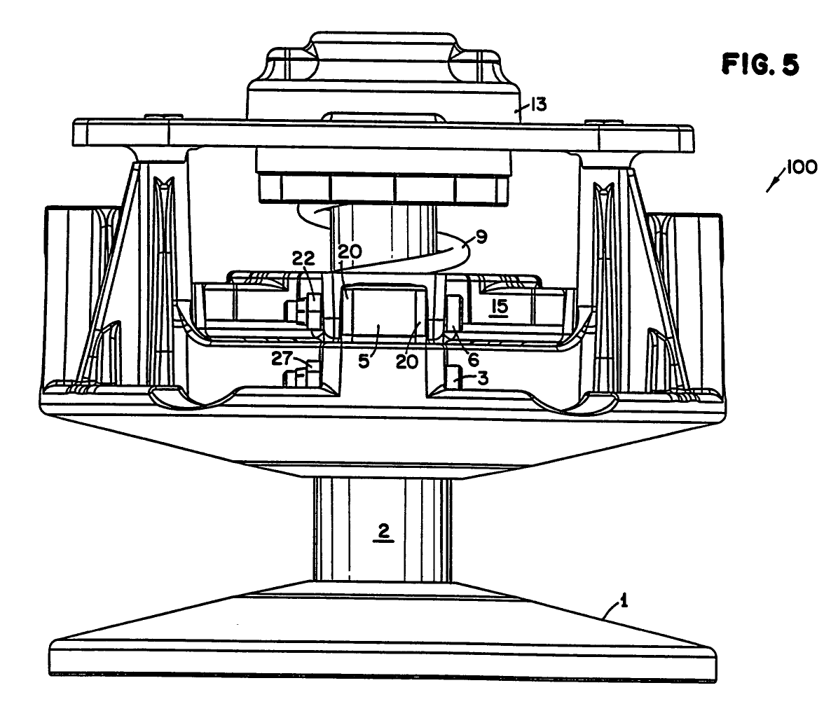

FIG. 6 is an exploded perspective view of the clutch shown in FIG. 1;

FIG. 7 is a perspective view of the adjuster and spider of the clutch shown in FIG. 1;

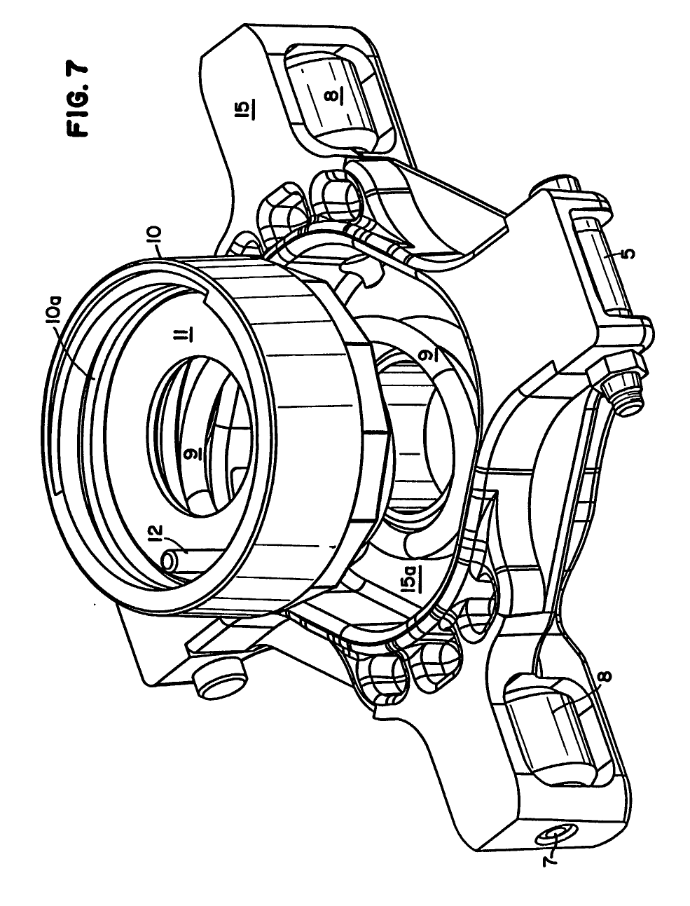

FIG. 8 is an enlarged perspective view of the moveable sheave and spider of the clutch shown in FIG. 1;

FIG. 9 is a cross-sectional view of the clutch, taken generally along the lines 3-3 as in FIG. 2, but showing the clutch in a second position; and

FIG. 10 is a cross-sectional view taken generally along the lines 10-10 in FIG. 2.

### DETAILED DESCRIPTION OF THE PREFERRED EMBODIMENT

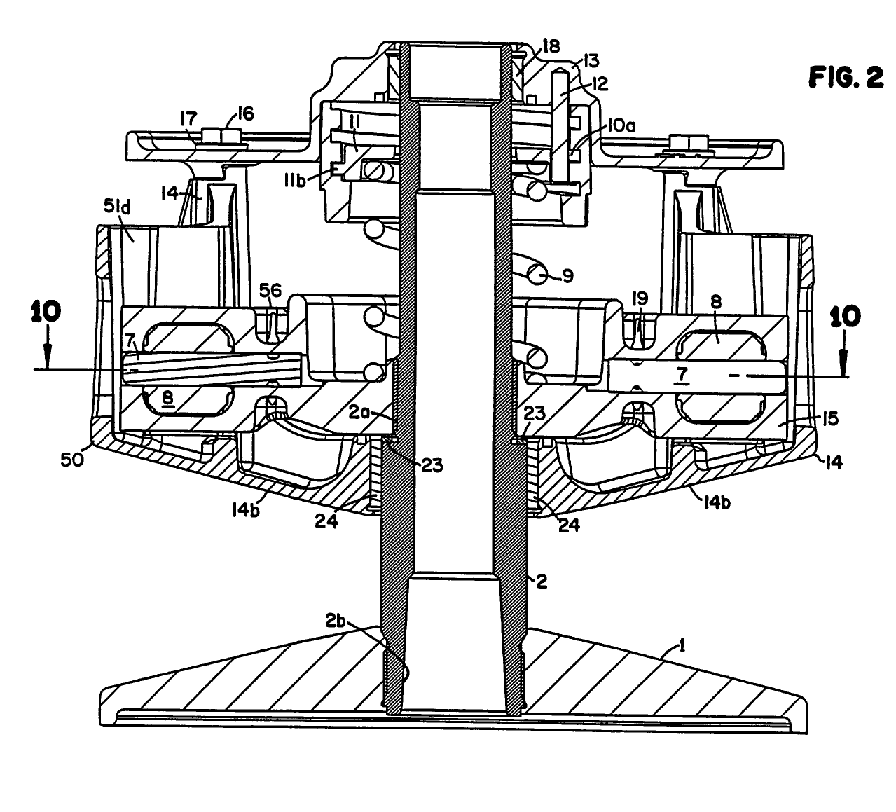

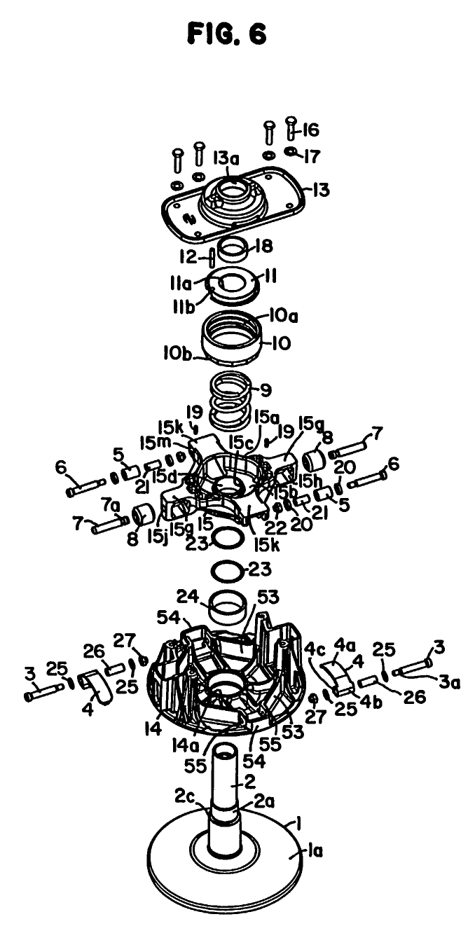

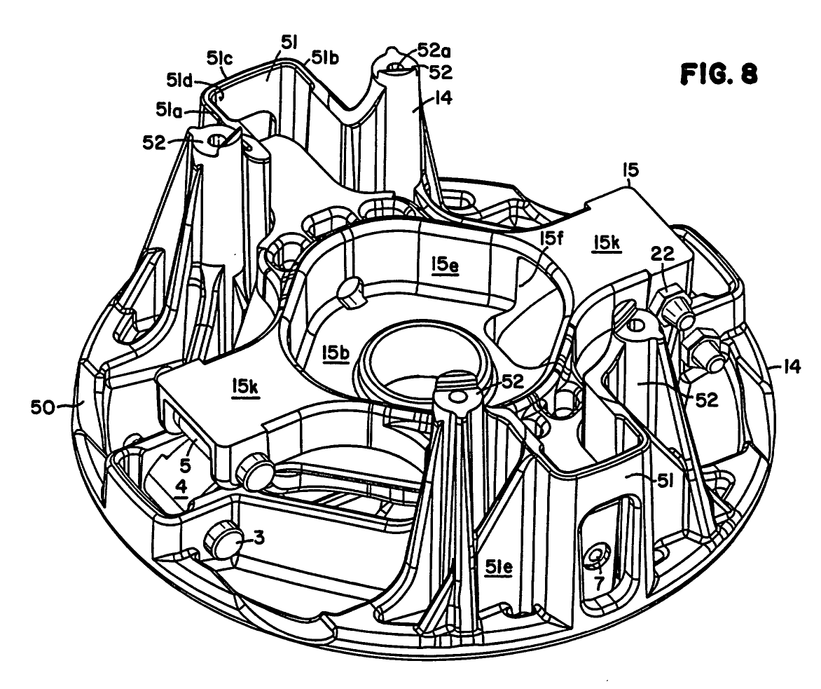

Referring to the drawing, wherein like numerals represent like parts throughout the several views, there is generally disclosed at 100 a primary clutch. The primary clutch has a moveable sheave 1 having a conical shaped belt-contacting portion 1a. A post 2 is secured to the moveable sheave 1 by suitable means such as threading the post 2 on to the moveable sheave 1, as shown in FIG. 2. It is of course understood that other suitable methods may be used to secure the post 2 securely to the moveable sheave 1. The post 2 has a threaded section 2a for use in threadably securing a spider 5 thereto, as will be described more fully hereafter. The post 2 has a longitudinal bore 2b extending through the post 2. The bore 2b is tapered at the bottom of the post 2 for use in connecting to a crank shaft of an engine. Just below the threaded portion 2a, a shoulder 2c is formed in the post 2. A moveable sheave 14 has a central opening 14a into which a bushing 24 is inserted. Two washers are positioned on top of the bushing 24. The bushing 24 and moveable sheave 14 is placed on the post 2 and the spacers 23 are positioned on the shoulder 2c. The moveable sheave 14 is slidable along the post 2, below the shoulder 2c. The moveable sheave 14 has a conical shaped, belt contacting surface 14b which, along with a conical shape 1a, provides for the contact with an endless V-belt (not shown). The moveable sheave 14 has a housing, generally designated at 50, that is operably connected to, and preferably integral with the conical shaped surface 14b. Referring especially to FIGS. 6 and 8, the housing 50 includes two transmission towers 51. The transmission towers 51 have side walls 51a and 51b connected by an intermediate wall 51c to form a slot 51d that extends in a direction generally perpendicular to the longitudinal axis of the post 2. Suitable reinforcing members 51 e are connected to the transmission towers to strengthen the towers 51, as is well known in the art. Four mounting posts 52 are formed as part of the housing 50 and have threaded openings 52a. Extending between the post 52 is a reinforcing member 53. The moveable sheave 14 is symmetrical and only one of the reinforcing members will be described in detail as the other is a mirror image thereof. The reinforcing member 53 spans the distance between two posts 52 and forms a three-sided pocket 54. A pair of openings 55 are formed in the pocket 54 and are used for mounting a flyweight 4 as will be described in more detail hereafter.

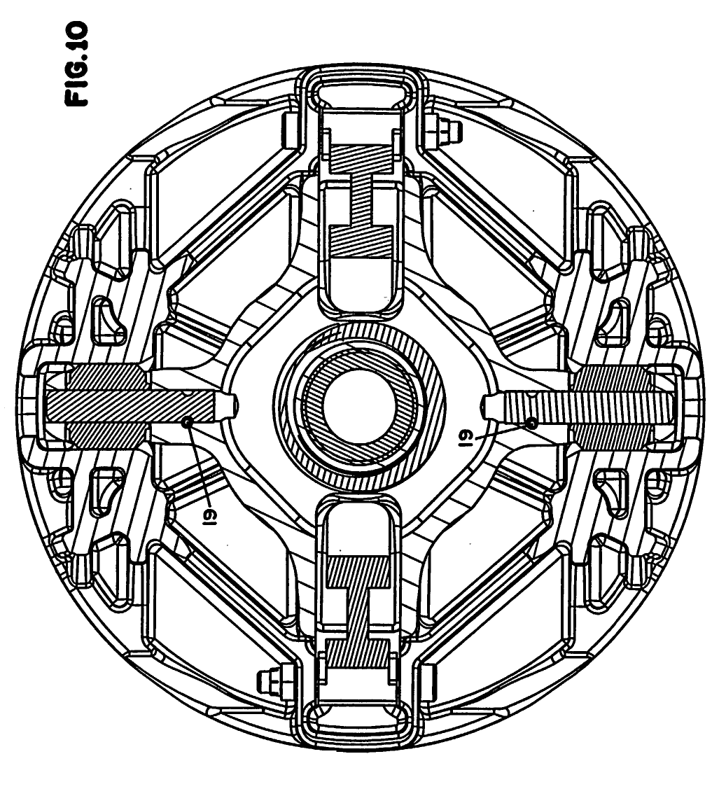

The flyweight 4 has a curved section 4a operatively connected to a cylindrical section 4b. A bore 4c extends through the cylindrical section 4b. A spacer 26 is positioned inside of the bore 4c. The cylindrical section 4b is placed inside of the pocket 54. Washers 25 are positioned between the cylindrical section 4b and the pocket 54. A pin 3 having a threaded end 3a is inserted through the opening 55 and through the cylindrical bore 4c and the flyweight is secured in position by a nut 27. The flyweight is free to rotate on the bolt 3 and spacer 26 as it is being acted upon by centrifugal force. A connector or spider 15 has a housing generally designated at 15a which includes a base 15b which has a circular opening 15c formed therein. Extending below the circular opening 15c is a threaded segment which is threaded on to the threaded portion 2a of the post 2, thereby securing the spider 15 to the post 2. A side member 15e is operatively connected to the base 15b. The side member 15e is continuous and forms a completed wall. There are two openings 15f formed in the side member 15e. The openings 15f are spaced at 180 degrees from each other and are positioned to allow the end of the flyweight 4 to not hit the spider side member 15e when the flyweights 4 are raised. Two transmission members 15g are operatively connected to and extend from the side member 15e. The transmission members 15g are spaced 180 degrees from each other, although it is understood other spacings may also be used. Formed in the transmission members 15g is an opening 15h. A roller 8 is positioned in the opening 15h and is secured by a pin 7 which extends through an opening 15j and into a bore formed in the roller 8. The pin 19 is inserted into an opening 56, as seen in FIG. 10, and extends to and contacts a recess 7a formed in the pin 7. The pin 19 forms a friction fit and thereby secures the pin 7 and roller 8 inside of the transmission members 15g. Spaced 90 degrees from the transmission members 15g are two belt-squeezing members 15k, although it is understood other spacings may also be used. The belt-squeezing members 15k are spaced 180 degrees from each other and extend from the side member 15e. The belt-squeezing members 15k are in the general shape of an inverted U-shaped channel, the end of which is open. Openings 15m are formed on each side of the U-shaped channel. Positioned inside of the U-shaped channel is a roller 5 which has a longitudinal bore extending there through into which a bushing 21 is positioned. The roller 5 is then positioned inside of the U-shaped channel with two washers on each side. Then, a pin 6 is inserted through the openings 15m and is secured by a nut 22. While the preferred embodiment utilizes a spider 15 as a connector, it is understood that suitable connectors of the post to the moveable sheave may be utilized.

A compression spring 9, for providing a preload, to bias the moveable sheave away from the stationary sheave, is positioned with a first end resting on the base 15b of the spider 15. A circular adjusting plate 11 has a central opening 11a formed therein. The opening 11a is sized to fit over the post 2. A circular flange member 11b extends around the base of the adjuster plate 11. The flange 1b is sized and configured to fit inside of the threaded pathway 10a of a cam or cap 10. As will be described more fully hereafter, as the cam 10 is rotated, the adjuster plate will move up and down, based on the rotation of the cam. At the base of the cam 10 is a plurality of straight segments 10b which are operatively connected to and form a base for the cam 10. The segments 10b create gripping areas for a wrench or other tool to rotate the cam 10. A cover 13 is secured to the moveable sheave 14 by four bolts 16 and washers 17 to the threaded openings 52a of the mounting posts 52. The cover has a recess in which the cam 10 is positioned. The cover 13 has an opening 13a in which a bearing 18 is positioned. The bearing 18 is positioned around the post 2. A pin 12 is fixedly secured to the underneath side of the cover 13. The pin 12 extends through a cutout 1b in the adjuster plate 11. This pin prevents the rotation of the adjuster plate 11. It is of course understood that other suitable methods of doing so may be utilized.

While the embodiment thus far described utilizes a cover plate, it is understood that other clutches may be of a different design and still utilize the present invention. The cover 13 is secured to the moveable sheave 14 and provides a means for allowing the compression spring to bias the moveable sheave 14 away from the stationary sheave 1. Other constructions could also be utilized wherein a compression spring is used to provide the preload but with a different configuration. For example, a moveable sheave could have a housing which extends upward along the post. A compression spring would be positioned between the top of the housing of the moveable sheave and a shoulder which would be formed on the post. Thereby, the compression spring would have one end resting on the shoulder on the post and the other end urging the moveable sheave upward through its housing member. The present invention could still be utilized to remotely adjust the compression spring of this or other constructions of clutches.

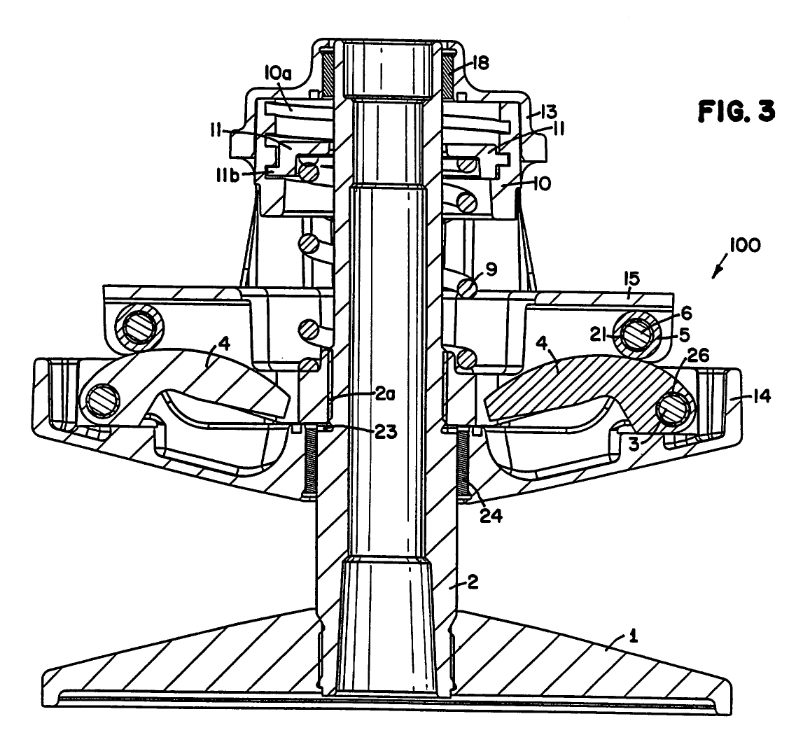

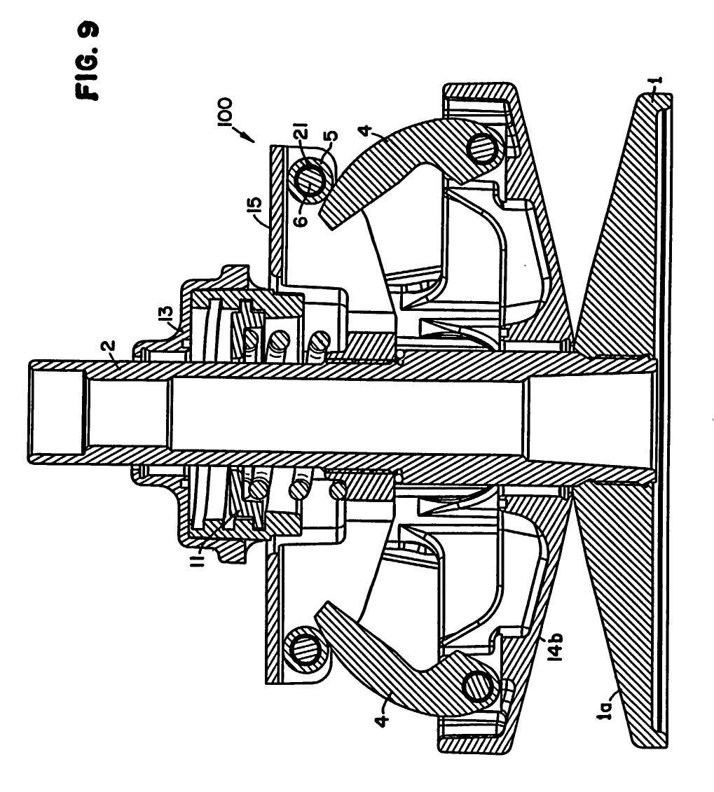

In operation, the primary clutch 100 begins in the position as shown in FIG. 3. Then, as rotation of the engine crankshaft causes rotation of the primary clutch as previously described, the flyweights 4 begin to pivot upward, around pin 3 because of centrifugal force. As the flyweights 4 move upward, the flyweight 4 contacts the roller 5 of the spider 15 and pushes on the spider 15. Since the spider 15 is fixed to the post 2, this moves the moveable sheave 14 downward, as shown in FIG. 9. The force of the flyweights 4 overcome the preload of the compression spring 9. In doing so, the movement together the two conical-shaped surfaces 1a and 14b provide for a belt-squeezing force on the V-shaped belt and the vehicle will again begin to move as the clutch has now become engaged. The belt-squeezing force is provided by the combination of the flyweight 4 attached to the moveable sheave 14 and contact with the roller 5, which is operatively connected to the spider 15. All of the side belt force is created by the pair of belt-squeezing members. The torque transmission, on the other hand, is provided by the two rollers 8 in the spider 15 positioned in the transmission towers 51. As the moveable sleeve 14 moves axially on the post 2, the rollers 8 move inside of the slots 51d. All of the torque transmission is provided by these pair of 180 degrees opposing rollers to the torque transmission towers 51. It can therefore be seen that the transfer of torque and the belt-squeezing force are applied separately and through separate and distinct components of the primary clutch 100. Further, the torque transmission and the belt side force are created by only two members. There are two rollers 8 for transmitting the torque and two flyweights 4 for the belt side force. The use of only two points is a significant benefit over the prior art which uses three or four or more point button system in which there are three or four points of contact to transmit torque. Then, you basically get a third bearing surface. During production settings, it is next to impossible to get the three bearing surface consistently coaxial. The three bearing surfaces are misaligned and binding can occur which creates a drop in clutch performance. The two points of contact of the present design will not act as a third bearing surface and will open up manufacturing tolerances, eliminate binding, allow the continuous variable transmission to react faster, have a longer life and be more efficient. The use of the two flyweights 4 instead of three or four or more allows for a freer running clutch with less drag and also provides for a lighter clutch. It is of course understood that other suitable methods of providing torque-power transmission and the belt-squeezing function may be utilized as are well known in the art. However, in one embodiment of the present invention, it is important that only two components and not the standard three or four or more components as is known in the prior art.

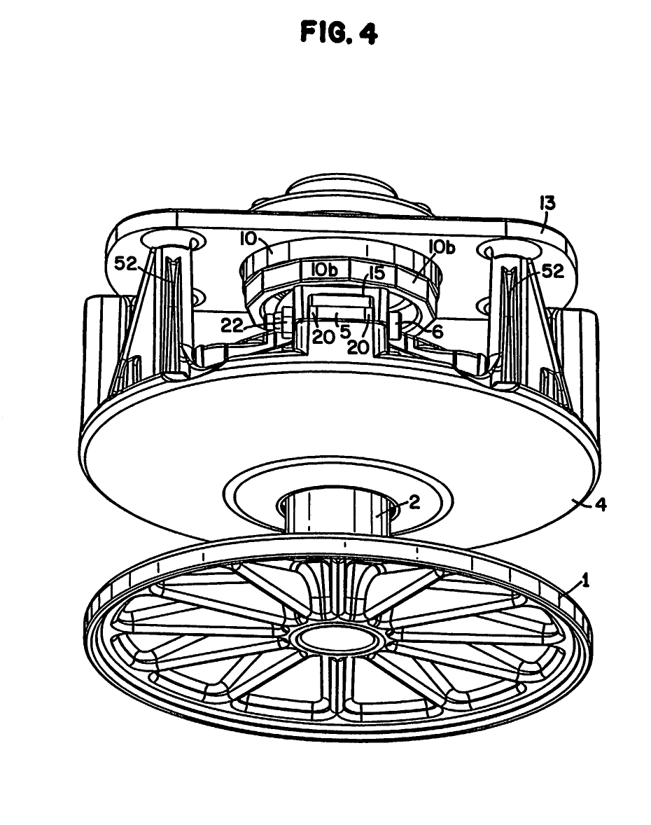

As previously stated, users will typically adjust or tune their clutch by changing the compression springs or changing flyweights. With the present invention, the tuning of the clutch is very easily made and also can be made in finer increments. To change the preload on the compression spring 9, it is only necessary to rotate the cam 10, thereby causing the adjuster plate 11 to move closer to or away from the end of the spring 9. This allows the spring 9 to either be compressed further or to become uncompressed, thereby changing the preload. As can be seen in FIG. 4, the surfaces 10b are readily available and the user can easily insert a wrench into the opening between the mounting post 52 to rotate the cam 10, thereby adjusting the preload. It is of course understood that other suitable adjustment mechanisms may be used to remotely change the compression force of the spring 9. When the term “remotely” is used in the present application, it is referring to changing the compression spring force without disassembly of the primary clutch 10. This makes it very convenient to adjust the compression spring force 9 when out in the cold as snowmobilers typically are. Further, since the compression spring force is able to be changed so easily, one can change it during the day easily as temperatures rise or fall, thereby effecting how the user would want to tune the clutch.

While the remotely adjusting of the preload has been described with respect to a cam and an adjuster plate that moves within the cam, it is understood that other suitable adjustments may be utilized. For instance, the cam 10 and adjuster plate 111 may be simply replaced with a cap with a threaded exterior. The threaded exterior could then be threaded on to the underneath side of the cover. The top of the spring 9 would bear against the cap and as the cap is rotated in its thread, the spring's preload would be adjusted. Still another method would be to have a sliding member with a ratcheting mechanism attached thereto. A ratchet mechanism could be constructed to cooperate with an adjuster plate. A pry bar or similar tool could be inserted into the ratchet mechanism to raise or lower the adjuster plate. A suitable locking mechanism could be utilized to lock the ratchet mechanism in position after the desired preload has been accomplished.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A continuously variable transmission drive element for mounting on an engine crank shaft and adapted for use in a belt-type continuously variable transmission operatively connected by an endless belt to a driven element, the drive element comprising:
a) a post;
b) a first, stationary sheave, having a conical faced belt-contacting portion, the first sheave operatively connected to the post;
c) a second, moveable sheave, the second sheave comprising:
i) a conical faced belt-contacting portion;
ii) a housing operatively connected to the conical faced portion;
iii) the housing having only a first and second torque transmission towers, each tower defining a longitudinal path, and only first and second belt-squeezing features;
d) a connector fixedly secured to the post, the connector having only a first and second torque transmission members and only a first and second belt-squeezing members, the torque transmission members slidable in the longitudinal path of the towers; and
e) a compression spring operatively connected to the moveable sheave to provide a biasing force tending to urge the moveable sheave away from the stationary sheave, wherein torque transmission is provided by only the first and second torque transmission towers and the first and second torque transmission members, and belt squeezing is provided only by the two belt-squeezing members and two belt-squeezing features.

2. The drive element of claim 1, further comprising the towers spaced 180 degrees from each other and the transmission members spaced 180 degrees from each other.

3. The drive element of claim 2, further comprising the belt-squeezing features spaced 180 degrees from each other and belt-squeezing members spaced 180 degrees from each other.

4. The drive element of claim 1, wherein the connector is a spider assembly.

5. The drive element of claim 4, further comprising a cover operatively connected to the moveable sheave and the spring having a first end proximate the cover and a second end proximately the spider assembly.

6. The drive element of claim 1, the belt-squeezing features each comprise a flyweight pivotally mounted to the housing and the belt-squeezing members each comprise a roller operatively connected to the spider assembly, wherein centrifugal force pivots the flyweights to contact and push the rollers, thereby moving the moveable sheave.

7. The drive element of claim 6, the torque transmission members each comprising a roller operatively connected to the spider assembly, the roller positioned in the longitudinal path, wherein the roller is rotatable as the moveable sheave moves relative to the stationary sheave and the rollers contact the longitudinal path to transmit torque.

8. The drive element of claim 7, further comprising the transmission towers spaced 90 degrees from the belt-squeezing features.

9. A continuously variable transmission drive element for mounting on an engine crank shaft and adapted for use in a belt-type continuously variable transmission operatively connected by an endless belt to a driven element, the drive element comprising:
a) a post;
b) a first, stationary sheave operatively connected to the post;
c) a second, moveable sheave coaxially mounted on the post;
d) a connector fixedly mounted to the post, wherein the connector and the second sheave operate to move the second sheave longitudinally along the post to provide for belt squeezing and also to transmit torque;
e) a compression spring operatively connected to the moveable sheave to provide a preload to bias the moveable sheave away from the stationary sheave; and
f) an adjuster to remotely change the preload.

10. The drive element of claim 9, further comprising the connector is a spider assembly and a cover is operatively connected to the moveable sheave.

11. The drive element of claim 9, the adjuster comprising a rotatable member and a spring contacting member, wherein rotation of the rotatable member results in longitudinal movement of the spring contacting member, thereby changing a preload of the spring.

12. A method of changing a preload on a compression spring in a continuously variable transmission drive element, the drive element having a preload compression spring operatively connected to a moveable sheave to provide a preload bias to urge the moveable sheave away from the stationary sheave, the method comprising:
a) assembling a drive element with a first preload on the spring; and
b) moving a spring preload adjusting member to cause longitudinal movement of a spring contacting member, thereby changing the first preload to a second preload, wherein the moving of the spring adjusting member is done remotely, without disassembling the drive element.

13. The method of claim 12, wherein moving the spring preload adjusting member further comprises rotating a cam member, wherein the rotating cam member results in movement of the adjusting member.

14. A continuously variable transmission drive element for mounting on an engine crank shaft and adapted for use in a belt-type continuously variable transmission operatively connected by an endless belt to a driven element, the drive element comprising:
a) a post;
b) a first, stationary sheave operatively connected to the post;
c) a second, moveable sheave coaxially mounted on the post;
d) a connector fixedly mounted to the post, wherein the connector and the second sheave operate to move the second sheave longitudinally along the post to provide for belt squeezing and also to transmit torque;
e) a compression spring operatively connected to the moveable sheave to provide a preload to bias the moveable sheave away from the stationary sheave; and
f) means for adjusting the preload remotely.
